(19) United States
(12) Patent Application Publication
(10) Pub. No.: US 2018/0229263 A1
(43) Pub. Date: Aug. 16, 2018

(54) METAL RESIN COMPOSITE MOLDED BODY AND METHOD FOR PRODUCING THE SAME

(71) Applicant: NIPPON LIGHT METAL COMPANY, LTD., Tokyo (JP)

(72) Inventors: Yusuke Nishikori, Shizuoka-shi (JP); Masanori Endo, Shizuoka-shi (JP); Miyuki Yoshida, Shizuoka-shi (JP)

(73) Assignee: NIPPON LIGHT METAL COMPANY, LTD., Tokyo (JP)

(21) Appl. No.: 15/580,175

(22) PCT Filed: Apr. 28, 2016
(86) PCT No.: PCT/JP2016/002235

§ 371 Date: Dec. 6, 2017

(30) Foreign Application Priority Data
Jun. 12, 2015 (JP) 2015-119133
Jul. 2, 2015 (JP) 2015-133409

(51) Int. Cl. B05D 3/10; B05D 7/14; B05D 7/24; B29C 45/14; B32B 15/085; B32B 15/20; B32B 27/34; B32B 27/36; B32B 38/00; C25D 11/04

(52) U.S. Cl. CPC B05D 3/107; B32B 2398/20; B05D 7/24; B29C 45/14311; B32B 15/085; B32B 15/20; B32B 27/34; B32B 27/365; B32B 38/0012; C25D 11/04; B32B 2038/002; B32B 2038/0052; B32B 2255/06; B32B 2307/728; B32B 2310/00; B32B 2311/24; B32B 2323/10; B32B 2369/00; B05D 7/14

(57) ABSTRACT

A metal resin composite molded body wherein various metal bases and a resin molded body are integrally and firmly bonded with each other; and a versatile method for producing this metal resin composite molded body are provided. Particularly provided are: a metal resin composite molded body wherein an aluminum base and a polyolefin resin molded body are integrally and firmly bonded with each other; and a simple method for producing this metal resin composite molded body. A metal resin composite molded body comprises a metal base, a polypropylene resin layer and a thermoplastic resin molded body. The polypropylene resin layer is bonded to the metal base with a hydrophilic surface being interposed therebetween. The hydrophilic surface is formed on the metal base. The thermoplastic resin molded body is bonded to the polypropylene resin layer by means of anchoring effect and compatibilizing effect with the polypropylene resin layer.

### TECHNICAL FIELD

The present invention relates to a metal resin composite molded body comprising a metal base and a resin molded body and a method for producing the body, and more specifically relates to a metal resin composite molded body where a metal base and a resin molded body are bonded integrally and firmly with each other, and a method for producing the body.

### BACKGROUND ART

Metal resin composite molded bodies where a metal material having excellent mechanical properties and a lightweight and inexpensive resin material having high insulation property are bonded integrally with each other have been widely used in various industrial fields.

Particularly in the fields of parts of various sensors of cars, parts of home electric products, parts of industrial equipment, and the like, there have been widely used aluminum resin composite molded bodies where an aluminum base of aluminum or an aluminum alloy having high heat radiation property and a thermoplastic resin molded body are integrally molded, and the uses of the bonded bodies have been expanded more.

Under these circumstances, various method for producing metal resin composite molded bodies have been studied intensively, and for example, Patent Document 1 (WO2012/060311) proposes a technique where after a polyolefin-based resin film is adhered to an aluminum base, insert molding is conducted to bond the resin to be injected and the aluminum base.

According to the above Patent Document 1, by laminating a tacky adhesive film containing a modified polyolefin-based resin where a polar group is introduced to a polyolefin-based resin onto a non-tacky thermoplastic resin film, it is possible to improve workability drastically when laminating the metal member and the adhesive film, and to obtain high heat resistance due to good adhesion of the metal member and the resin to be injection-molded.

Further, Patent Document 2 (JP2014-34201A) proposes a metal member—propylene resin foamed member composite body which is obtained by integrating a metal member which is surface-treated by physical treatment and/or chemical treatment and a propylene resin foamed member.

According to the above Patent Document 2, by insert-expansion molding after subjecting an aluminum base to surface-treatment such as anodizing treatment, it is possible to make a composite body where the aluminum base and the propylene resin foamed member are integrated being excellent in sealing property and bonding property together with lightweight.

### PRIOR ART DOCUMENT

### Patent Document

Patent Document 1: WO2012/060311

Patent Document 2: JP2014-34201A

### SUMMARY OF THE INVENTION

### Problem to be Solved by the Invention

However, in the method for producing the metal resin composite body described in Patent Document 1, since it is necessary to use the adhesive film, the applying method is restricted, and thus it is difficult to use popularly. In the metal resin composite body described in Patent Document 2, the bonding strength of the aluminum base and the propylene resin foamed member is not enough.

Further, other than the above Patent Documents 1 and 2, there have been proposed a method where fine unevenness is previously formed on a metal base to improve bonding strength between the metal base and a resin molded body, a method where an adhesive is applied to the interface to be bonded of a metal base and a resin molded body to improve bonding strength, and the like, but kinds of the resin molded bodies to be applied are restricted. Particularly, since a polyolefin-based resin represented by polypropylene resin has a low polarity and further has no functional group which can contribute chemical bonding, it is difficult to chemically bond to a metal base. Further, since a polyolefin-based resin has a large shrinkage rate after cooling because of its high linear expansion coefficient, it is easy to slip out from the fine unevenness of the metal surface (large anchor effect cannot be expected).

Considering the aforementioned problem in the prior arts, the present invention is to provide a metal resin composite molded body where a various metal base and resin molded body are bonded integrally and firmly with each other, and a general method for producing the body, and particularly, to provide a metal resin composite molded body where an aluminum base and a polyolefin-based resin molded body are bonded integrally and firmly with each other, and a simple method for producing the body.

### Means to Solve the Problems

In order to realize the above object, as a result of the incentive study as to a metal resin composite molded body and a method for producing the body, the present inventors have found that it is extremely effective that a resin molded body is injection-molded with a proper processing temperature to a metal base where a polypropylene resin layer is formed by coating method, and then the present invention has been completed.

Namely, the present invention provides a metal resin composite molded body, which comprises

a metal base,

a polypropylene resin layer and

a thermoplastic resin molded body; and

the polypropylene resin layer is bonded to the metal base via a hydrophilic surface which is formed on the metal base, and

the thermoplastic resin molded body is bonded to the polypropylene resin layer by means of anchoring effect and compatibilizing effect with the polypropylene resin layer.

In the metal resin composite molded body of the present invention, the polypropylene resin layer is strongly bonded to the metal base by reacting a modified maleic acid anhydride in the polypropylene resin with an OH group on the hydrophilic surface of the metal base to produce strong bonding.

Further, near the bonding interface of the thermoplastic resin molded body and the polypropylene resin layer is uneven in addition to well compatibilized condition. Namely, according to the metal resin composite molded body of the present invention, since both the anchoring effect and compatibilizing effect are generated at the same time, the thermoplastic resin molded body and the polypropylene resin layer are bonded extremely strong.

In the metal resin composite molded body of the present invention, it is preferable that the metal resin composite molded body is obtainable by steps comprising

a first step of forming the polypropylene resin layer on the metal base by coating, and

a second step of injection-molding a polypropylene resin to the polypropylene resin-coated metal base obtained in the first step to fuse the polypropylene resin layer and the polypropylene resin by heat generated at the injection molding; and

the condition of the injection molding in the second step satisfies the equation of T(gap)={(Temperature of the polypropylene resin)−(Melting point of polypropylene resin layer)}−{(Melting point of polypropylene resin layer)−(Temperature of die)}≥0.

The {(Temperature of the polypropylene resin)−(Melting point of polypropylene resin layer)} is a difference between a temperature of the polypropylene resin melted by heating with a cylinder and a melting point of the polypropylene resin layer and means an energy to melt the polypropylene resin layer, and the {(Melting point of polypropylene resin layer)−(Temperature of die)} is a difference between the melting point of the polypropylene resin layer and a temperature of a die and means an energy to reduce an energy for melting the polypropylene resin layer.

Here, as the result of the inventors' various experiments and discussion, when the injection molding is carried out under the condition of T(gap)≥0, it has been found that, in addition to the fact that sufficient compatibilizing effect can be obtained near the bonding interface between the thermoplastic resin molded body and the polypropylene resin layer, the bonding interface can be endowed with sufficient unevenness (anchor effect), Namely, when the injection molding is carried out under the condition of T(gap)≥0, the compatibilizing effect and the anchor effect can be generated at the same time, and the polypropylene resin molded body and the polypropylene resin layer can be bonded extremely strong.

In case that the thermoplastic resin molded body is a polyamide resin molded body, it is preferable that in the second step, a polyamide resin is injection-molded to the polypropylene resin-coated metal base obtained in the first step to fuse the polypropylene resin layer and the polyamide resin by heat generated at the injection molding; and

the condition of the injection molding in the second step satisfies the equation of T(gap)={(Temperature of the polyamide resin)−(Melting point of polypropylene resin layer)}−{(Melting point of polypropylene resin layer)−(Temperature of die)}≥0.

Even in case that a polyamide resin which is different from the polypropylene resin layer formed on the surface of the metal base is used, when the polyamide resin is injection-molded under the condition that satisfies the equation of T(gap)={(Temperature of the polyamide resin)−(Melting point of polypropylene resin layer)}−{(Melting point of polypropylene resin layer)−(Temperature of die)}≥0, as in the same manner when the polypropylene resin is injection-molded, the compatibilizing effect and the anchor effect can be generated at the same time, and the polyamide resin molded body and the polypropylene resin layer can be bonded extremely strong.

In case that the thermoplastic resin molded body is a polycarbonate resin molded body, it is preferable that in the second step, a polycarbonate resin is injection-molded to the polypropylene resin-coated metal base obtained in the first step to fuse the polypropylene resin layer and the polycarbonate resin by heat generated at the injection molding; and

the condition of the injection molding in the second step satisfies the equation of T(gap)={(Temperature of the polycarbonate resin)−(Melting point of polypropylene resin layer)}−{(Melting point of polypropylene resin layer)−(Temperature of die)}≥0.

Even in case that a polycarbonate resin which is different from the polypropylene resin layer formed on the surface of the metal base is used, when the polycarbonate resin is injection-molded under the condition that satisfies the equation of T(gap)={(Temperature of the polycarbonate resin)−(Melting point of polypropylene resin layer)}−{(Melting point of polypropylene resin layer)−(Temperature of die)}≥0, as in the same manner when the polypropylene resin is injection-molded, the compatibilizing effect and the anchor effect can be generated at the same time, and the polycarbonate resin molded body and the polypropylene resin layer can be bonded extremely strong.

Further, in the metal resin composite molded body of the present invention, it is preferable that the metal base is an aluminum base composed of aluminum or an aluminum alloy. When the metal base is the aluminum base composed of aluminum or an aluminum alloy, it is possible not only to make the metal resin composite molded body light but also to utilize high heat radiation property of the aluminum base.

Further, in the metal resin composite molded body of the present invention, it is preferable that the aluminum base is subjected to at least one surface treatment selected from the group consisting of caustic treatment, blasting treatment, anodizing treatment, beohmite treatment and roughening treatment, and a contact angle of the polypropylene resin which forms the polypropylene resin layer and the aluminum base is 60 degrees or less.

When the aluminum base is subjected to at least one surface treatment selected from the group consisting of caustic treatment, blasting treatment, anodizing treatment, beohmite treatment and roughening treatment, it is possible to realize the formation of the hydrophilic surface of the aluminum base and/or the increase of the surface roughness of the aluminum base. Further, when the contact angle of the polypropylene resin which forms the polypropylene resin layer and the aluminum base is 60 degrees or less, it is possible to form the polypropylene resin layer easily by coating method.

Further, in the metal resin composite molded body of the present invention, it is preferable that a film thickness of the polypropylene resin layer is 1 to 200 μm. When the film thickness of the polypropylene resin layer is 1 μm or more, due to heat insulation effect of the polypropylene resin layer, the polypropylene resin layer can be sufficiently melted by the thermal energy at the injection molding. Further, when the film thickness of the polypropylene resin layer is 200 μm or less, a homogeneous polypropylene resin layer can be formed by coating method. More preferable film thickness of the polypropylene resin layer is 10 to 60 μm.

Furthermore, in the metal resin composite molded body of the present invention, it is preferable that the polypropylene resin layer is formed by spray coating or powder coating in the first step. When the polypropylene resin layer is formed by spray coating or powder coating, even if the metal base has a complicated surface or a large surface area, a homogeneous polypropylene resin layer can be formed easily.

Further, the present invention provides a method for producing a metal resin composite molded body, comprising:

a first step of forming the polypropylene resin layer on the metal base by coating, and

a second step of injection-molding a polypropylene resin to the polypropylene resin-coated metal base obtained in the first step to fuse the polypropylene resin layer and the polypropylene resin by heat generated at the injection molding; and

the condition of the injection molding in the second step satisfies the equation of T(gap)={(Temperature of the polypropylene resin)−(Melting point of polypropylene resin layer)}−{(Melting point of polypropylene resin layer)−(Temperature of die)}≥0.

The method for producing a metal resin composite molded body of the present invention can be applied to a metal resin composite molded body where the metal base and a polyamide resin molded body are bonded, and in such a case, the method comprises

a first step of forming the polypropylene resin layer on the metal base by coating, and

a second step of injection-molding a polyamide resin to the polypropylene resin-coated metal base obtained in the first step to fuse the polypropylene resin layer and the polyamide resin by heat generated at the injection molding; and

the condition of the injection molding in the second step satisfies the equation of T(gap)={(Temperature of the polyamide resin)−(Melting point of polypropylene resin layer)}−{(Melting point of polypropylene resin layer)−(Temperature of die)}≥0.

Here, the meaning of T(gap)≥0 is the same as the case of the aforementioned metal resin composite molded body of the present invention.

The method for producing a metal resin composite molded body of the present invention can be applied to a metal resin composite molded body where the metal base and a polycarbonate resin molded body are bonded, and in such a case, the method comprises

a first step of forming the polypropylene resin layer on the metal base by coating, and

a second step of injection-molding a polycarbonate resin to the polypropylene resin-coated metal base obtained in the first step to fuse the polypropylene resin layer and the polycarbonate resin by heat generated at the injection molding; and

the condition of the injection molding in the second step satisfies the equation of T(gap)={(Temperature of the polycarbonate resin)−(Melting point of polypropylene resin layer)}−{(Melting point of polypropylene resin layer)−(Temperature of die)}≥0.

Here, the meaning of T(gap)≥0 is the same as the case of the aforementioned metal resin composite molded body of the present invention.

In the method for producing the metal resin composite molded body of the present invention, it is preferable that the metal base is an aluminum base composed of aluminum or an aluminum alloy. When the metal base is the aluminum base composed of aluminum or an aluminum alloy, it is possible to realize the formation of the hydrophilic surface and surface unevenness of the metal base easily.

Further, in the method for producing the metal resin composite molded body of the present invention, it is preferable that the aluminum base is subjected to at least one surface treatment selected from the group consisting of caustic treatment, blasting treatment, anodizing treatment, beohmite treatment and roughening treatment, and a contact angle of the polypropylene resin which forms the polypropylene resin layer and the aluminum base is 60 degrees or less.

When the aluminum base is subjected to at least one surface treatment selected from the group consisting of caustic treatment, blasting treatment, anodizing treatment, beohmite treatment and roughening treatment, it is possible to realize the formation of the hydrophilic surface of the aluminum base and/or the increase of the surface roughness of the aluminum base. Further, when the contact angle of the polypropylene resin which forms the polypropylene resin layer and the aluminum base is 60 degrees or less, it is possible to form the polypropylene resin layer easily by coating method.

Further, in the method for producing the metal resin composite molded body of the present invention, it is preferable that a film thickness of the polypropylene resin layer is 1 to 200 μm. When the film thickness of the polypropylene resin layer is 1 μm or more, due to heat insulation effect of the polypropylene resin layer, the polypropylene resin layer can be sufficiently melted by the thermal energy at the injection molding. Further, when the film thickness of the polypropylene resin layer is 200 μm or less, a homogeneous polypropylene resin layer can be formed by coating method. More preferable film thickness of the polypropylene resin layer is 10 to 60 μm.

Furthermore, in the method for producing the metal resin composite molded body of the present invention, it is preferable that the polypropylene resin layer is formed by spray coating or powder coating in the first step. When the polypropylene resin layer is formed by spray coating or powder coating, even if the metal base has a complicated surface or a large surface area, a homogeneous polypropylene resin layer can be formed easily.

### Effects of the Invention

According to the present invention, it is possible to provide a metal resin composite molded body where a various metal base and resin molded body are bonded integrally and firmly with each other, and a general method for producing the body, and particularly, to provide a metal resin composite molded body where an aluminum base and a polyolefin-based resin molded body are bonded integrally and firmly with each other, and a simple method for producing the body.

### BRIEF DESCRIPTION OF THE DRAWINGS

FIG. 1 is a schematic sectional view showing the metal resin composite molded body of the present invention.

FIG. 2 is a diagram showing the theory of bonding of the polypropylene resin layer and the metal base.

FIG. 3 is a flow chart showing the method for producing for the metal resin composite molded body of the present invention.

FIG. 4 is a schematic photograph and schematic view of the specimen for measuring peel strength.

FIG. 5 is a view for showing the situation of measuring peel strength.

FIG. 6 is a SEM photograph of the sectional view of the metal resin composite molded body according to the example.

FIG. 7 is a SEM photograph of the sectional view of the metal resin composite molded body according to the comparative example.

FIG. 8 is a graph showing the relation between the processing temperature of the injection molding and the peel strength.

### MODE FOR CARRYING OUT THE INVENTION

In the following, by referring the drawings, typical embodiments of the metal resin composite molded body of the present invention and the method for producing thereof are explained, but the present invention is not limited thereto. In the following explanation, the same symbol is given to the same or corresponding parts, and there is a case where overlapping explanation is omitted. In addition, since these drawings are presented to explain the concept of the present invention, there are cases where size and ratio of the structural elements are different from the real case.

### (1) Metal Resin Composite Molded Body

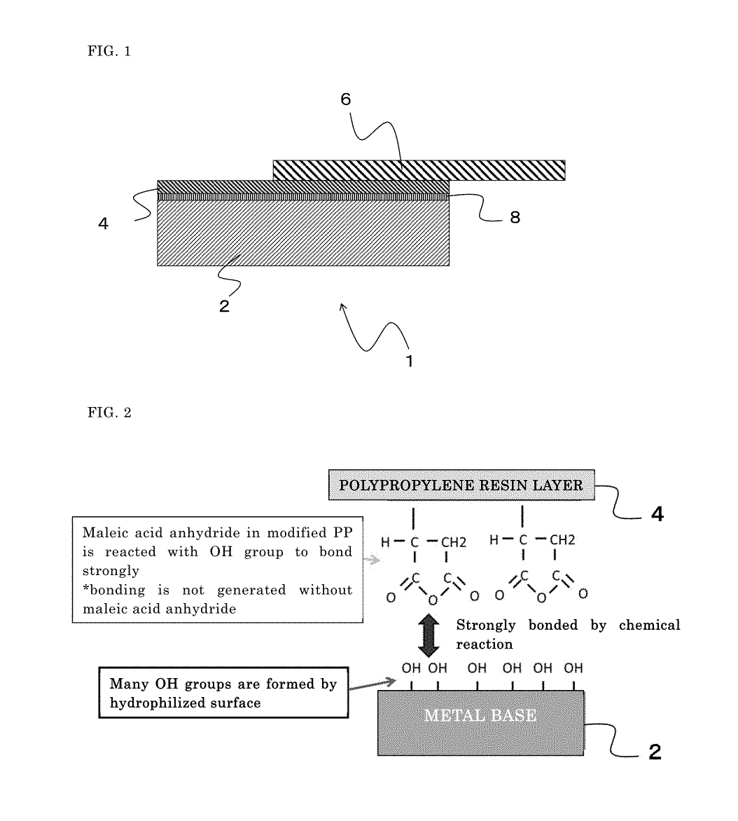

FIG. 1 is a schematic sectional view showing the metal resin composite molded body of the present invention. The metal resin composite molded body 1 has a metal base 2, a polypropylene resin layer 4, and a thermoplastic resin molded body 6, and the polypropylene resin layer 4 is bonded to the metal base 2 via a hydrophilic surface 8 formed on the metal base 2, and the thermoplastic resin molded body 6 is bonded to the polypropylene resin layer 4 by the compatibilizing effect and the anchor effect of the polypropylene resin layer 4.

The metal base 2 is not particularly limited as long within the range that does not impair the effect of the present invention, and can be made of known conventional various kinds of metal bases, but it is preferable to use an aluminum base composed of aluminum or an aluminum alloy.

Further, the thermoplastic resin molded body 6 is not particularly limited as long within the range that does not impair the effect of the present invention, and can be made of known conventional various kinds of thermoplastic resin molded body. Furthermore, there can be used a polyolefin-based resin represented by the polypropylene resin which is remarkably difficult to chemically bond to the metal base 2, because, in addition to low polarity, the resin has no functional group which can contribute chemical bonding and has high linear expansion coefficient, and further there can be used the polyamide resin and the polycarbonate resin which are different in kind from the polypropylene resin.

In case that the thermoplastic resin molded body 6 is the polypropylene resin molded body, the metal resin composite molded body 1 is obtainable by steps comprising the first step of forming the polypropylene resin layer 4 on the metal base 2 by coating, and the second step of injection-molding the polypropylene resin to the polypropylene resin-coated metal base obtained in the first step to fuse the polypropylene resin layer 4 and the polypropylene resin by heat generated at the injection molding; wherein the condition of the injection molding in the second step preferably satisfies the equation of T(gap)={(Temperature of the polypropylene resin)−(Melting point of polypropylene resin layer)}−{(Melting point of polypropylene resin layer)−(Temperature of die)}≥0.

As mentioned above, the {(Temperature of the polypropylene resin)−(Melting point of polypropylene resin layer)} is a difference between a temperature of the polypropylene resin melted by heating with a cylinder and a melting point of the polypropylene resin layer 4 and means an energy to melt the polypropylene resin layer 4, and the {(Melting point of polypropylene resin layer)−(Temperature of die)} is a difference between the melting point of the polypropylene resin layer 4 and a temperature of a die and means an energy to reduce an energy for melting the polypropylene resin layer 4.

Here, when the injection molding is carried out under the condition of T(gap)≥0, in addition to the fact that sufficient compatibilizing effect can be obtained near the bonding interface between the thermoplastic resin molded body 6 and the polypropylene resin layer 4, the bonding interface can be endowed with sufficient unevenness (anchor effect). Namely, when the injection molding is carried out under the condition of T(gap)≥0, the compatibilizing effect and the anchor effect can be generated at the same time, and the polypropylene resin molded body (thermoplastic resin molded body 6) and the polypropylene resin layer 4 can be bonded extremely strong.

In case that the thermoplastic resin molded body 6 is the polyamide resin molded body, in the second step, the metal resin composite molded body 1 is obtainable by injection-molding the polyamide resin to the polypropylene resin-coated metal base obtained in the first step to fuse the polypropylene resin layer 4 of the polypropylene resin-coated metal base and the polyamide resin by heat generated at the injection molding; wherein the condition of the injection molding in the second step preferably satisfies the equation of T(gap)={(Temperature of the polyamide resin)−(Melting point of polypropylene resin layer)}−{(Melting point of polypropylene resin layer)−(Temperature of die)}≥0.

Even in case that a polyamide resin which is different from the polypropylene resin layer 4 formed on the surface of the metal base 2 is used, when the polyamide resin is injection-molded under the condition that satisfies the equation of T(gap)={(Temperature of the polyamide resin)−(Melting point of polypropylene resin layer)}−{(Melting point of polypropylene resin layer)−(Temperature of die)}≥0, as in the same manner when the polypropylene resin is injection-molded, the compatibilizing effect and the anchor effect can be generated at the same time, and the polyamide resin molded body (thermoplastic resin molded body 6) and the polypropylene resin layer 4 can be bonded extremely strong.

In case that the thermoplastic resin molded body 6 is the polycarbonate resin molded body, in the second step, the metal resin composite molded body 1 is obtainable by injection-molding the polycarbonate resin to the polypropylene resin-coated metal base obtained in the first step to fuse the polypropylene resin layer 4 of the polypropylene resin-coated metal base and the polycarbonate resin by heat generated at the injection molding; wherein the condition of the injection molding in the second step preferably satisfies the equation of T(gap)={(Temperature of the polycarbonate resin)−(Melting point of polypropylene resin layer)}−{(Melting point of polypropylene resin layer)−(Temperature of die)}≥0.

Even in case that a polycarbonate resin which is different from the polypropylene resin layer 4 formed on the surface of the metal base 2 is used, when the polycarbonate resin is injection-molded under the condition that satisfies the equation of T(gap)={(Temperature of the polycarbonate resin)−(Melting point of polypropylene resin layer)}−{(Melting point of polypropylene resin layer)−(Temperature of die)}≥0, as in the same manner when the polypropylene resin is injection-molded, the compatibilizing effect and the anchor effect can be generated at the same time, and the polycarbonate resin molded body (thermoplastic resin molded body 6) and the polypropylene resin layer 4 can be bonded extremely strong.

FIG. 2 is a diagram showing the theory of bonding of the polypropylene resin layer 4 and the metal base 2. The polypropylene resin layer 4 is strongly bonded to the metal base 2 by reacting a modified maleic acid anhydride in the polypropylene resin of the polypropylene resin layer 4 with an OH group on the hydrophilic surface 8 of the metal base 2 to produce strong bonding.

In case that the aluminum base is used as the metal base 2 is the aluminum base, it is preferable that the aluminum base is subjected to at least one surface treatment selected from the group consisting of caustic treatment, blasting treatment, anodizing treatment, beohmite treatment and roughening treatment, and a contact angle of the polypropylene resin which forms the polypropylene resin layer 4 and the aluminum base is 60 degrees or less.

When the aluminum base is subjected to at least one surface treatment selected from the group consisting of caustic treatment, blasting treatment, anodizing treatment, beohmite treatment and roughening treatment, it is possible to realize the formation of the hydrophilic surface 8 of the aluminum base and/or the increase of the surface roughness of the aluminum base. Further, when the contact angle of the polypropylene resin which forms the polypropylene resin layer 4 and the aluminum base is 60 degrees or less, it is possible to form the polypropylene resin layer 4 easily by coating method.

Here, by subjecting to the caustic treatment, anodizing treatment and beohmite treatment, the OH group on the hydrophilic surface 8 can be increased, and by subjecting to the blasting treatment and roughening treatment, the surface of the metal base 2 (aluminum base) can be roughened. When subjecting to the caustic treatment, the resulting contact angle is approximately 40 degrees, when subjecting to the beohmite treatment, the resulting contact angle is approximately 20 degrees, and when subjecting to the anodizing treatment, the resulting contact angle is approximately 20 degrees.

When the metal resin composite molded body 1 is used under highly humid circumstance, water passes through the polypropylene resin layer 4 to form a hydrate on the surface of the metal base 2 (aluminum base). Since the formation of the hydrate makes the adhesion between the polypropylene resin layer 4 and the metal base 2 (aluminum base), when the metal resin composite molded body 1 is used under highly humid circumstance, it is preferable to previously subject to hydrated oxide treatment to inhibit the hydration reaction caused thereafter.

Further, it is preferable that a film thickness of the polypropylene resin layer 4 is 1 to 200 μm. When the film thickness of the polypropylene resin layer 4 is 1 μm or more, due to heat insulation effect of the polypropylene resin layer 4, the polypropylene resin layer 4 can be sufficiently melted by the thermal energy at the injection molding. Further, when the film thickness of the polypropylene resin layer 4 is 200 μm or less, a homogeneous polypropylene resin layer 4 can be formed by coating method. More preferable film thickness of the polypropylene resin layer 4 is 10 to 60 μm.

Furthermore, it is preferable that the polypropylene resin layer 4 is formed by spray coating or powder coating in the first step. When the polypropylene resin layer 4 is formed by spray coating or powder coating, even if the metal base 2 has a complicated surface or a large surface area, a homogeneous polypropylene resin layer 4 is formed.

The metal resin composite molded body of the present invention can be produced suitably by the method for producing the metal resin composite molded body of the present invention.

### (2) Method for Producing Metal Resin Composite Molded Body

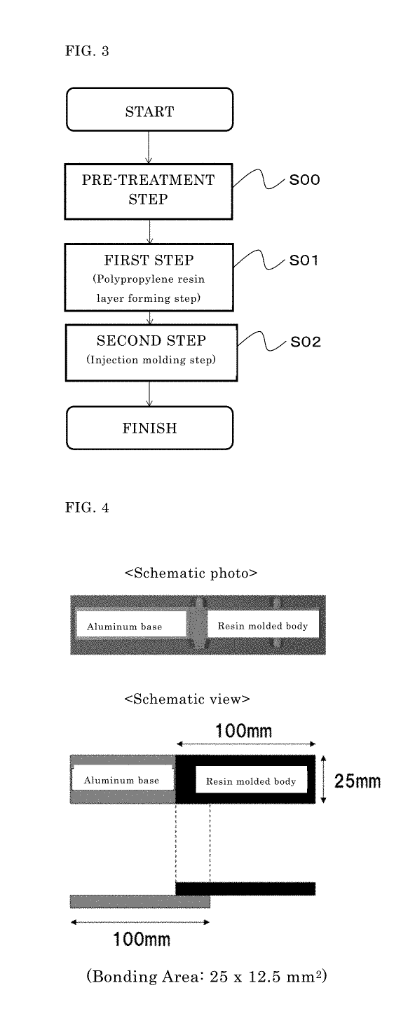

FIG. 3 is a flow chart showing the method for producing for the metal resin composite molded body of the present invention. The method for producing the metal resin composite molded body of the present invention is a method for producing a metal resin composite molded body where various metal base and resin molded body are bonded integrally and firmly with each other, and includes a first step (S01) where the polypropylene resin layer is formed on the surface of the metal base, and a second step (S02) where the polypropylene resin layer and the resin molded body are fused by injection molding, and, if necessary, a pre-treatment step (S00) may be applied to the surface of the metal base. In the following, each step is explained in detail.

### (2-1) Pre-Treatment Step (S00)

The pre-treatment step (S00) is a step where the formation of the hydrophilic surface and/or surface unevenness of the metal base are carried out. From the viewpoint that an oxide coating film (hydrophilic surface) can be formed to a certain degree even in non-treated state, it is preferable to use the aluminum base composed of aluminum or an aluminum alloy, and even if the aluminum base is used, it is preferable to form a better hydrophilic surface.

The practical pre-treatment to the metal base is not particularly limited as long within the range that does not impair the effect of the present invention, and known conventional various surface treatment can be employed. When the aluminum base is used as the metal base, it is preferable that the aluminum base is subjected to at least one surface treatment selected from the group consisting of caustic treatment, blasting treatment, anodizing treatment, beohmite treatment and roughening treatment, and a contact angle of the polypropylene resin which forms the polypropylene resin layer and the base is 60 degrees or less.

When the aluminum base is subjected to at least one surface treatment selected from the group consisting of caustic treatment, blasting treatment, anodizing treatment, beohmite treatment and roughening treatment, it is possible to realize the formation of the hydrophilic surface of the aluminum base and/or the increase of the surface roughness of the aluminum base. Further, when the contact angle of the polypropylene resin which forms the polypropylene resin layer and the aluminum base is 60 degrees or less, it is possible to form the polypropylene resin layer easily in the first step (S01) by coating method.

The pre-treatment step (S00) may be applied to the region where the polypropylene resin layer may be formed in the first step (S01).

### (2-2) First Step (S01: Polypropylene Resin Layer Forming Step)

The first step (S01) is a step for forming the polypropylene resin layer on the surface of the metal base by coating method.

The film thickness of the polypropylene resin layer to be formed is preferably 1 to 200 μm. When the film thickness of the polypropylene resin layer is 1 μm or more, due to heat insulation effect of the polypropylene resin layer, the polypropylene resin layer can be sufficiently melted by the thermal energy at the injection molding in the second step (S02). Further, when the film thickness of the polypropylene resin layer is 200 μm or less, a homogeneous polypropylene resin layer can be formed by coating method. More preferable film thickness of the polypropylene resin layer is 10 to 60 μm.

The polypropylene resin layer is preferably formed by spray coating or powder coating. When the polypropylene resin layer is formed by spray coating or powder coating, even if the metal base has a complicated surface or a large surface area, a homogeneous polypropylene resin layer can be formed.

The first step (S01) may be applied to the region where the resin molded body and the metal base are fused in the second step (S02).

### (2-3) Second Step (S02: Injection Molding)

The second step (S02) is a step for fusing the polypropylene resin layer and the resin molded body by injection molding.

In case that the polypropylene resin molded body is used as the resin molded body, when the injection molding is carried out under the condition where the equation of T(gap)={(Temperature of the polypropylene resin)−(Melting point of polypropylene resin layer)}−{(Melting point of polypropylene resin layer)−(Temperature of die)}≥0 is satisfied, it is possible to obtain a metal resin composite molded body where the polypropylene resin layer and the polypropylene resin molded body are strongly and firmly bonded.

In case that the polyamide resin molded body is used as the resin molded body, when the injection molding is carried out under the condition where the equation of T(gap)={(Temperature of the polyamide resin)−(Melting point of polypropylene resin layer)}−{(Melting point of polypropylene resin layer)−(Temperature of die)}≥0 is satisfied, it is possible to obtain a metal resin composite molded body where the polypropylene resin layer and the polyamide resin molded body are strongly and firmly bonded.

In case that the polycarbonate resin molded body is used as the resin molded body, when the injection molding is carried out under the condition where the equation of T(gap)={(Temperature of the polycarbonate resin)−(Melting point of polypropylene resin layer)}−{(Melting point of polypropylene resin layer)−(Temperature of die)}≥0 is satisfied, it is possible to obtain a metal resin composite molded body where the polypropylene resin layer and the polycarbonate resin molded body are strongly and firmly bonded.

In every case that, as the resin molded body, the polypropylene resin molded body is used, that the polyamide resin molded body is used, and that the polycarbonate resin molded body is used, when the injection molding is carried out under the condition of T(gap)≥0, the compatibilizing effect and the anchor effect of the resin molded body and the polypropylene resin layer can be generated at the same time, and the resin molded body and the polypropylene resin layer can be bonded extremely strong. Here, for example, in case that the polypropylene resin molded body is used, a die temperature is 30 to 80° C., and a cylinder temperature is 190 to 250° C., in case that the polyamide resin molded body is used, a die temperature is 30 to 160° C., and a cylinder temperature is 200 to 360° C., and in case that the polycarbonate resin molded body is used, a die temperature is 60 to 110° C., and a cylinder temperature is 260 to 320° C.

The injection molding conditions other than the temperature conditions is not particularly limited as long within the range that does not impair the effect of the present invention, and known conventional various injection molding conditions can be employed.

In the above, the typical embodiments of the present invention are explained by referring Examples and Comparative Examples, but the present invention is not limited to these embodiments, and various changes in design may be possible, those changes may be included within the scope of the present invention.

### EXAMPLE

### Example

An aluminum base of 100 mm×25 mm size was cut out from a commercially available aluminum plate (A1050, plate thickness 2 mm) or an aluminum alloy plate (A5052 or A6061, plate thickness 2 mm), and thereafter was subjected to the pre-treatment step (S00), the first step (S01) and the second step (S02) to obtain present metal resin composite molded bodies 1 to 28 as the examples of the present invention. Details of each step were as follows.

### 1. Pre-Treatment Step (S00)

As the pre-treatment step (S00), one or two of A treatment to D treatment mentioned in the following (1) to (4) were carried out. The treatment used for producing each metal resin composite molded body is shown in Table 1 or Table 2.

### (1) Beohmite Treatment: A Treatment

An aluminum base was dipped into a 30% nitric acid aqueous solution for 1 minute at room temperature, and thereafter, dipped into a 5% sodium hydroxide aqueous solution at 50° C. for 1 minute, and further dipped into a 30% nitric acid aqueous solution for 1 minute at room temperature. Next, the base was dipped into a hot water (pure water or water soluble amine solution) of 60° C. to 100° C. for 0.5 to 30 minutes to obtain a surface-treated aluminum base where a hydrated oxide coating film containing beohmite or pseudobeomite as a main component was formed on the surface.

### (2) Roughening Treatment: B Treatment

An aluminum base was dipped into a 30% nitric acid aqueous solution for 1 minute at room temperature, and thereafter, dipped into a 5% sodium hydroxide aqueous solution at 50° C. for 1 minute, and further dipped into a 30% nitric acid aqueous solution for 1 minute at room temperature. Next, the base was dipped into a treating solution which contains a 20% of acidic ammonium fluoride as a main component (available from The Japan Cee-Bee Chemical Co., Ltd.: JCB-3712) at 40° C. for 10 minutes, and thereafter, dipped into a 30% nitric acid aqueous solution for 1 minute at room temperature to obtain a roughening-treated aluminum base.

### (3) Anodizing Treatment: C Treatment

An aluminum base was dipped into a 30% nitric acid aqueous solution for 1 minute at room temperature, and thereafter, dipped into a 5% sodium hydroxide aqueous solution at 50° C. for 1 minute, and further dipped into a 30% nitric acid aqueous solution for 1 minute at room temperature. Next, the base was anodized in a 180 g/L of a sulfuric acid solution at 18° C. by passing a direct current of 18 V so that a film thickness was 10 μm to obtain an anodized aluminum base.

### (4) Caustic Treatment: D Treatment

An aluminum base was dipped into a 30% nitric acid aqueous solution for 1 minute at room temperature, and thereafter, dipped into a 5% sodium hydroxide aqueous solution at 50° C. for 1 minute, and further dipped into a 30% nitric acid aqueous solution for 1 minute at room temperature to obtain a caustic-treated aluminum base.

A contact angle of a water drop on the surface of the surface-treated aluminum base was measured. The measurement of the contact angle was conducted according to a drop method by using a automatic contact angle gauge DM-701 (available from Kyowa Interface Science Co., Ltd.). The results are shown in Table 1 or Table 2.

### 2. First Step (S01)

A polypropylene resin was applied to the aluminum base after the surface treatment (pre-treatment step (S00)). As the paints for application to the base, there were used two kinds of polypropylene resins, i.e. a paint A (Hardlen TD-15B, melting point 95° C., available from TOYOBO CO., LTD.) and a paint B (Hardlen NZ-1022, melting point 130° C., available from TOYOBO CO., LTD.). The paint used for producing the present metal resin composite molded body is shown in Table 1 or Table 2.

The application of the paint was carried out by spray coating, and then, heating by a warm air dryer under given conditions was carried out to obtain a polypropylene resin layer having a film thickness of 20 to 60 μm. Here, in case of the paint A, the warm air drying conditions were at 80° C. for 15 minutes, and in case of the paint B, the warm air drying conditions were at 100° C. for 15 minutes.

### 3. Second Step (S02)

As the resin molded article, the polypropylene resin molded body, the polyamide resin molded body or the polycarbonate resin molded body were used, the resin molded body was fused to the polypropylene resin layer by the injection molding. The resin molded body and the injection molding conditions (die temperature and cylinder temperature) used for producing the present metal resin composite molded body are shown in Table 1 or Table 2.

In case that the polypropylene resin molded body was use as the resin molded body, the aluminum base after painting (first step (S01)) was set in a die, a polypropylene resin (WELNEX CTR0755C, available from Japan Polypropylene Corporation) was injected into the die under the injection molding conditions, i.e. an injection speed of 10 mm/s, a keeping pressure 30 MPa, a pressure keeping period 8 seconds to obtain the present metal resin composite molded body (aluminum/polypropylene resin composite molded body) of 100 mm×25 mm×2 mm. The molded body was bonded to the aluminum base within an area of 25 mm×12.5 mm at the molding.

In case that the polyamide resin molded body was use as the resin molded body, the aluminum base after painting (first step (S01)) was set in a die, a polyamide resin (Leona 90G33, available from Asahi Kasei Chemicals Corporation) was injected into the die under the injection molding conditions, i.e. an injection speed of 10 mm/s, a keeping pressure 40 MPa, a pressure keeping period 8 seconds to obtain the present metal resin composite molded body (aluminum/polyamide resin composite molded body) of 100 mm×25 mm×2 mm. The molded body was bonded to the aluminum base within an area of 25 mm×12.5 mm at the molding.

In case that the polycarbonate resin molded body was use as the resin molded body, the aluminum base after painting (first step (S01)) was set in a die, a polycarbonate resin (Upion S-300N, available from Mitsubishi Engineering Plastic Corporation) was injected into the die under the injection molding conditions, i.e. an injection speed of 15 mm/s, a keeping pressure 110 MPa, a pressure keeping period 10 seconds to obtain the present metal resin composite molded body (aluminum/polycarbonate resin composite molded body) of 100 mm×25 mm×2 mm. The molded body was bonded to the aluminum base within an area of 25 mm×12.5 mm at the molding.

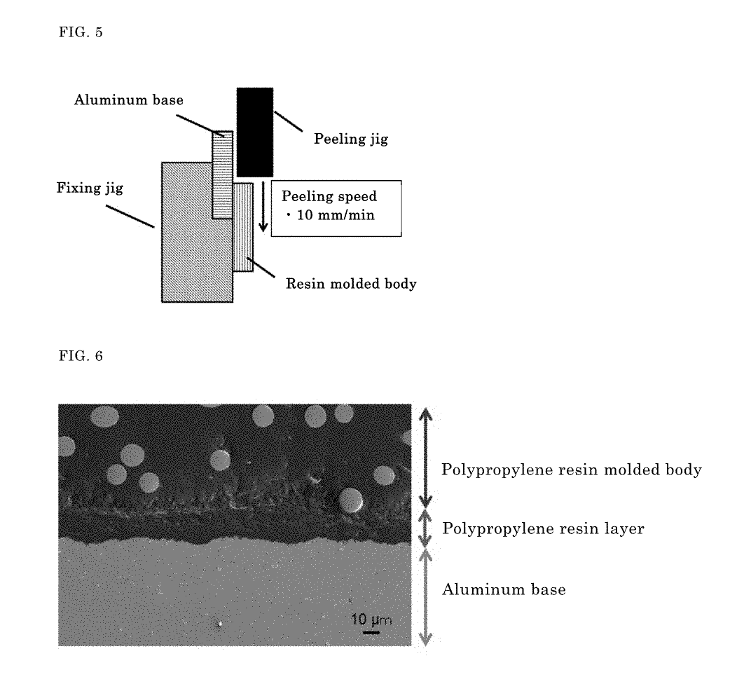

A specimen for measuring a peel strength having the shape shown in FIG. 4 was cut from the obtained metal resin composite molded body, a test of destroying the bonding part between the metal and the resin was conducted by fixing the metal resin composite molded body to a jig in the manner as shown in FIG. 5, applying a load to the upper end of the resin molded body from the upper side at a speed of 10 mm/min. The break force when the metal resin composite molded body was broken is a peeling strength, and the results are shown in Table 1 or Table 2.

### Comparative Example

Comparative metal resin composite molded bodies 1 to 8 were obtained according to the same procedures as in Example excepting that the production conditions and the injection molding conditions shown in Table 1 were employed. The measurement of the contact angle and the peeling strength test were conducted in the same manner as in Example, and the results are shown in Table 3.

TABLE 1
PP: Polypropylene

| Present metal resin | | | | | | | | | | |
|---|---|---|---|---|---|---|---|---|---|---|
| composite molded body | | 1 | 2 | 3 | 4 | 5 | 6 | 7 | 8 | 9 |
| Base | | A5052 | A5052 | A5052 | A5052 | A5052 | A5052 | A5052 | A5052 | A5052 |
| Surface treatment 1 | | A | A | A | A | A | A | A | A | A |
| Surface treatment 2 | | — | — | — | — | — | — | — | — | — |
| Contact angle (°) | | 15 | 15 | 15 | 15 | 15 | 15 | 15 | 15 | 15 |
| Paint PP melting point (° C.) | | 95 | 95 | 95 | 130 | 95 | 95 | 95 | 95 | 130 |
| Film thickness (μm) | | 20 | 40 | 40 | 40 | 40 | 40 | 40 | 40 | 40 |
| Injected resin | | PP | PP | PP | PP | PP | PP | PP | PP | PP |
| Resin molding | Cylinder Temp. (° C.) | 190 | 260 | 190 | 260 | 230 | 250 | 220 | 250 | 230 |
| condition | Die Temp. (° C.) | 50 | 50 | 50 | 50 | 50 | 50 | 80 | 80 | 50 |
| T(gap) | | 50 | 120 | 50 | 50 | 90 | 110 | 110 | 140 | 20 |
| Evaluation of | Peeling strength | 14.1 | 15.5 | 14.0 | 14.4 | 14.2 | 14.1 | 13.7 | 13.6 | 13.6 |
| bonding strength | (MPa) | | | | | | | | | |

| Present metal resin | | | | | | |
|---|---|---|---|---|---|---|
| composite molded body | | 10 | 11 | 12 | 13 | 14 |
| Base | | A5052 | A5052 | A5052 | A5052 | A5052 |
| Surface treatment 1 | | A | A | A | A | A |
| Surface treatment 2 | | — | — | — | — | — |
| Contact angle (°) | | 15 | 15 | 15 | 15 | 15 |
| Paint PP melting point (° C.) | | 130 | 130 | 130 | 130 | 130 |
| Film thickness (μm) | | 40 | 40 | 40 | 60 | 60 |
| Injected resin | | PP | PP | PP | PP | PP |
| Resin molding | Cylinder Temp. (° C.) | 250 | 220 | 250 | 260 | 250 |
| condition | Die Temp. (° C.) | 50 | 80 | 80 | 50 | 80 |
| T(gap) | | 40 | 40 | 70 | 50 | 70 |
| Evaluation of | Peeling strength | 14.2 | 12.2 | 12.2 | 12.9 | 14.3 |
| bonding strength | (MPa) | | | | | |

TABLE 2
PP: Polypropylene, PA: Polyamide, PC: Polycarbonate

| Present metal resin | | | | | | | | | | |
|---|---|---|---|---|---|---|---|---|---|---|
| composite molded body | | 15 | 16 | 17 | 18 | 19 | 20 | 21 | 22 | 23 |
| Base | | A5052 | A5052 | A5052 | A5052 | A5052 | A5052 | A1050 | A6061 | A5052 |
| Surface treatment 1 | | B | C | D | B | C | D | A | A | A |
| Surface treatment 2 | | A | — | — | A | — | — | — | — | — |
| Contact angle (°) | | 15 | 15 | 40 | 15 | 15 | 40 | 15 | 15 | 15 |
| Paint PP melting point (° C.) | | 95 | 95 | 95 | 130 | 130 | 130 | 95 | 95 | 95 |
| Film thickness (μm) | | 40 | 40 | 40 | 40 | 40 | 40 | 40 | 40 | 20 |
| Injected resin | | PP | PP | PP | PP | PP | PP | PP | PP | PA |
| Resin molding | Cylinder Temp. (° C.) | 260 | 260 | 260 | 260 | 260 | 260 | 260 | 260 | 300 |
| condition | Die Temp. (° C.) | 50 | 50 | 50 | 50 | 50 | 50 | 50 | 50 | 60 |
| T(gap) | | 120 | 120 | 120 | 50 | 50 | 50 | 120 | 120 | 170 |
| Evaluation of | Peeling strength | 14.9 | 11.2 | 10.3 | 13.0 | 10.5 | 10.2 | 16.4 | 14.3 | 6.8 |
| bonding strength | (MPa) | | | | | | | | | |

| Present metal resin | | | | | | |
|---|---|---|---|---|---|---|
| composite molded body | | 24 | 25 | 26 | 27 | 28 |
| Base | | A5052 | A5052 | A5052 | A5052 | A5052 |
| Surface treatment 1 | | A | A | A | A | A |
| Surface treatment 2 | | — | — | — | — | — |
| Contact angle (°) | | 15 | 15 | 15 | 15 | 15 |
| Paint PP melting point (° C.) | | 95 | 95 | 130 | 130 | 95 |
| Film thickness (μm) | | 40 | 40 | 40 | 40 | 40 |
| Injected resin | | PA | PA | PA | PA | PC |
| Resin molding | Cylinder Temp. (° C.) | 300 | 300 | 300 | 300 | 280 |
| condition | Die Temp. (° C.) | 60 | 80 | 100 | 120 | 80 |
| T(gap) | | 170 | 190 | 140 | 160 | 170 |
| Evaluation of | Peeling strength | 8.1 | 7.0 | 5.7 | 6.7 | 3.4 |
| bonding strength | (MPa) | | | | | |

TABLE 3
PP: Polypropylene, PA: Polyamide, PC: Polycarbonate

| Comparative metal resin | | | | | | | | | |
|---|---|---|---|---|---|---|---|---|---|
| composite molded body | | 1 | 2 | 3 | 4 | 5 | 6 | 7 | 8 |
| Base | | A5052 | A5052 | A5052 | A5052 | A5052 | A5052 | A1050 | A6061 |
| Surface treatment 1 | | A | A | A | Only | B | A | B | A |
| | | | | | degreasing | | | | |
| Surface treatment 2 | | — | — | — | — | A | — | A | — |
| Contact angle (°) | | 15 | 15 | 15 | 80 | 15 | 15 | 15 | 15 |
| Paint PP melting point (° C.) | | 130 | 130 | 130 | 95 | No | — | — | — |
| | | | | | | painting | | | |
| Film thickness (μm) | | 20 | 40 | 60 | *1) | — | — | — | — |
| Injected resin | | PP | PP | PP | — | PP | PA | PA | PC |
| Resin molding | Cylinder Temp. (° C.) | 190 | 190 | 190 | — | 190 | 300 | 300 | 280 |
| condition | Die Temp. (° C.) | 50 | 50 | 50 | — | 50 | 140 | 140 | 80 |
| T(gap) | | −20 | −20 | −20 | — | — | | | |
| Evaluation of | Peeling strength | 4.2 | 5.4 | 2.7 | — | 3.1 | 2.1 | 3.2 | 0 |
| bonding strength | (MPa) | | | | | | | | |

*1)Cannot be painted

The present metal resin composite molded bodies 1 to 28 were all broken at the resin molded bodies in the peeling strength test, and shew high peeling strength. To the contrary, in Comparative Example (comparative metal resin composite molded bodies 1 to 8), breakage was happened at the bonding interface of the polypropylene resin layer and the resin molded body, and enough interface bonding strength could not be obtained.

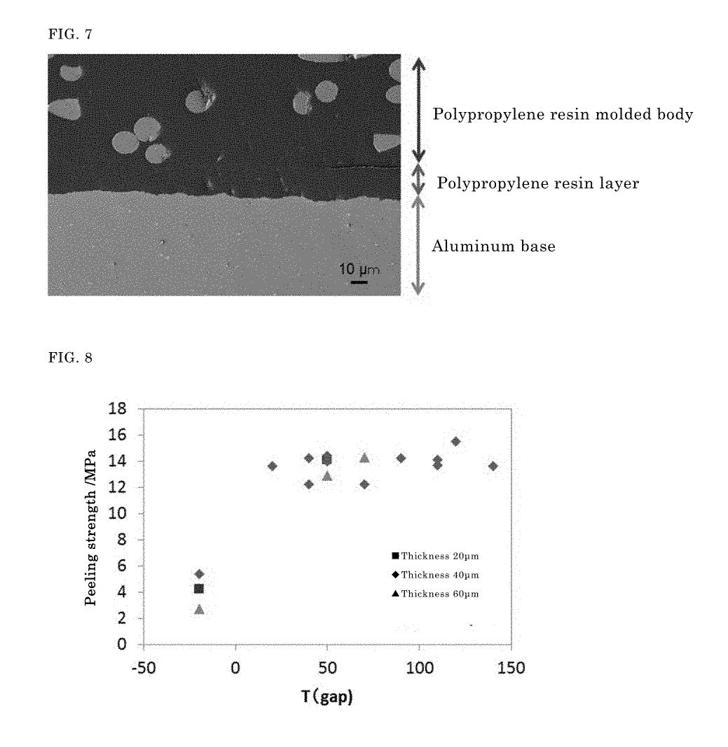

In FIG. 6 and FIG. 7, sectional SEM photographs of the present metal resin composite molded body 1 (Example 1) and the comparative metal resin composite molded body 1 (Comparative Example 1) are shown respectively. It is understood that the present metal resin composite molded body has larger unevenness at the bonding interface between the polypropylene resin layer and the polypropylene resin molded body than that of the comparative metal resin composite molded body. Further, though the interface of the comparative metal resin composite molded body is peeled partly, the interface of the present metal resin composite molded body is completely bonded. It is assumed that by generating the anchor effect due to the unevenness of the bonding interface and the compatibilizing effect between the polypropylene resin layer and the polypropylene resin molded body at the same time, the present metal resin composite molded body shows high peeling strength.

FIG. 8 shows the relation between T(gap) and the peeling strength in the present metal resin composite molded bodies 1 to 14 and the comparative metal resin composite molded bodies 1 to 3. The present metal resin composite molded bodies 1 to 14 where T(gap)≥0 is satisfied show high peeling strength due to the breakage at the resin molded body, but the comparative metal resin composite molded bodies 1 to 3 where T(gap)≥0 is not satisfied show low peeling strength due to the breakage at the bonding interface between the polypropylene resin layer and the resin molded body.

### EXPLANATION OF SYMBOLS

1 Metal resin composite molded body
2 Metal base
4 Polypropylene resin layer
6 Thermoplastic resin molded body
8 Hydrophilic surface

1. A metal resin composite molded body, which comprises
a metal base,
a polypropylene resin layer and
a thermoplastic resin molded body; and
the polypropylene resin layer is bonded to the metal base via a hydrophilic surface which is formed on the metal base, and
the thermoplastic resin molded body is bonded to the polypropylene resin layer by means of anchoring effect and compatibilizing effect with the polypropylene resin layer.

2. The metal resin composite molded body according to claim 1, wherein,
the metal resin composite molded body is obtainable by steps comprising
a first step of forming the polypropylene resin layer on the metal base by coating, and
a second step of injection-molding a polypropylene resin to the polypropylene resin-coated metal base obtained in the first step to fuse the polypropylene resin layer and the polypropylene resin by heat generated at the injection molding; and
the condition of the injection molding in the second step satisfies the equation of T(gap)={(Temperature of the polypropylene resin)−(Melting point of polypropylene resin layer)}−{(Melting point of polypropylene resin layer)−(Temperature of die)}≥0.

3. The metal resin composite molded body according to claim 1, wherein,
in the second step, a polyamide resin is injection-molded to the polypropylene resin-coated metal base obtained in the first step to fuse the polypropylene resin layer and the polyamide resin by heat generated at the injection molding; and
the condition of the injection molding in the second step satisfies the equation of T(gap)={(Temperature of the polyamide resin)−(Melting point of polypropylene resin layer)}−{(Melting point of polypropylene resin layer)−(Temperature of die)}≥0.

4. The metal resin composite molded body according to claim 1, wherein,
in the second step, a polycarbonate resin is injection-molded to the polypropylene resin-coated metal base obtained in the first step to fuse the polypropylene resin layer and the polycarbonate resin by heat generated at the injection molding; and
the condition of the injection molding in the second step satisfies the equation of T(gap)={(Temperature of the polycarbonate resin)−(Melting point of polypropylene resin layer)}−{(Melting point of polypropylene resin layer)−(Temperature of die)}≥0.

5. The metal resin composite molded body according to claim 1, wherein the metal base is an aluminum base composed of aluminum or an aluminum alloy.

6. The metal resin composite molded body according to claim 5, wherein the aluminum base is subjected to at least one surface treatment selected from the group consisting of caustic treatment, blasting treatment, anodizing treatment, beohmite treatment and roughening treatment, and
a contact angle of the polypropylene resin which forms the polypropylene resin layer and the aluminum base is 60 degrees or less.

7. The metal resin composite molded body according to claim 1, wherein a film thickness of the polypropylene resin layer is 1 to 200 μm.

8. The metal resin composite molded body according to claim 2, wherein the polypropylene resin layer is formed by spray coating or powder coating in the first step.

9. A method for producing a metal resin composite molded body, comprising:
a first step of forming the polypropylene resin layer on the metal base by coating, and
a second step of injection-molding a polypropylene resin to the polypropylene resin-coated metal base obtained in the first step to fuse the polypropylene resin layer and the polypropylene resin by heat generated at the injection molding; and
the condition of the injection molding in the second step satisfies the equation of T(gap)={(Temperature of the polypropylene resin)−(Melting point of polypropylene resin layer)}−{(Melting point of polypropylene resin layer)−(Temperature of die)}≥0.

10. A method for producing a metal resin composite molded body, comprising:
a first step of forming the polypropylene resin layer on the metal base by coating, and
a second step of injection-molding a polyamide resin to the polypropylene resin-coated metal base obtained in the first step to fuse the polypropylene resin layer and the polyamide resin by heat generated at the injection molding; and
the condition of the injection molding in the second step satisfies the equation of T(gap)={(Temperature of the polyamide resin)−(Melting point of polypropylene resin layer)}−{(Melting point of polypropylene resin layer)−(Temperature of die)}≥0.

11. A method for producing a metal resin composite molded body, comprising:
a first step of forming the polypropylene resin layer on the metal base by coating, and
a second step of injection-molding a polycarbonate resin to the polypropylene resin-coated metal base obtained in the first step to fuse the polypropylene resin layer and the polycarbonate resin by heat generated at the injection molding; and
the condition of the injection molding in the second step satisfies the equation of T(gap)={(Temperature of the polycarbonate resin)−(Melting point of polypropylene resin layer)}—{(Melting point of polypropylene resin layer)−(Temperature of die)}≥0.

12. The method for producing a metal resin composite molded body according to claim 9, wherein the metal base is an aluminum base composed of aluminum or an aluminum alloy.

13. The method for producing a metal resin composite molded body according to claim 9, wherein the aluminum base is subjected to at least one surface treatment selected from the group consisting of caustic treatment, blasting treatment, anodizing treatment, beohmite treatment and roughening treatment, and
a contact angle of the polypropylene resin which forms the polypropylene resin layer and the aluminum base is 60 degrees or less.

14. The method for producing a metal resin composite molded body according to claim 9, wherein a film thickness of the polypropylene resin layer is 1 to 200 μm.

15. The method for producing a metal resin composite molded body according to claim 9, wherein the polypropylene resin layer is formed bay spray coating or powder coating in the first step.

16. The method for producing a metal resin composite molded body according to claim 10, wherein the metal base is an aluminum base composed of aluminum or an aluminum alloy.

17. The method for producing a metal resin composite molded body according to claim 11, wherein the metal base is an aluminum base composed of aluminum or an aluminum alloy.

18. The method for producing a metal resin composite molded body according to claim 10, wherein the aluminum base is subjected to at least one surface treatment selected from the group consisting of caustic treatment, blasting treatment, anodizing treatment, beohmite treatment and roughening treatment, and
a contact angle of the polypropylene resin which forms the polypropylene resin layer and the aluminum base is 60 degrees or less.

19. The method for producing a metal resin composite molded body according to claim 11, wherein the aluminum base is subjected to at least one surface treatment selected from the group consisting of caustic treatment, blasting treatment, anodizing treatment, beohmite treatment and roughening treatment, and
a contact angle of the polypropylene resin which forms the polypropylene resin layer and the aluminum base is 60 degrees or less.

20. The method for producing a metal resin composite molded body according to claim 10, wherein a film thickness of the polypropylene resin layer is 1 to 200 μm.
